(19) United States
(12) Patent Application Publication
(10) Pub. No.: US 2004/0194371 A1
(43) Pub. Date: Oct. 7, 2004

(54) Greenhouse climate control system

(76) Inventor: Ralph Arthur Kinnis, Delta (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/406,803

(22) Filed: Apr. 2, 2003

(51) Int. Cl. A01G 9/00

(52) U.S. Cl. 47/17

(57) ABSTRACT

This invention relates to a greenhouse climate control system for controlling the air exchange rate, temperature, and relative humidity (RH) level in a greenhouse. The system has at least one air processing unit that obtains return air from the greenhouse, processes the air, and returns the processed air as supply air back into the greenhouse. Return air is obtained from a location in the greenhouse above the canopy of a crop grown in the greenhouse, and supply air is returned to the greenhouse through perforated distribution tubes located in the vicinity of the crops.

### FIELD OF THE INVENTION

The invention relates generally to a climate control system for a greenhouse.

### BACKGROUND OF THE INVENTION

A greenhouse is an enclosure for cultivating and protecting plants inside the greenhouse from the outside environment. Greenhouses are designed to control the balance of temperature, moisture, CO₂ content, and light to suit the growth requirements for plants, and particularly, for tender plants or plants grown out of season.

The temperature and relative humidity (RH) conditions inside the greenhouse will depend on the type of plant grown in the greenhouse. Some plants require substantially the same temperature and RH to be maintained 24 hours a day, while other plants will require very specific temperature changes at different times of the day. The temperature outside the greenhouse of course affects the temperature inside. Further, solar radiation during a sunny day can heat the greenhouse, dramatically increasing the inside temperature.

Typical energy sources used to heat greenhouses include natural gas, propane, wood, coal, solar radiation, and electricity. Some of the energy sources can be used directly to heat the greenhouse, wherein others such as propane or natural gas are burned in a gas-fired boiler to heat water. The heated water is distributed through heat-conductive pipes that typically are located near the plants to be heated. The heat released by these pipes is typically distributed around the greenhouse by a series of fans that are used to circulate air.

Cooling the greenhouse may be achieved via a number of ways. For example, wall and roof vents may be provided that are opened to allow outside ambient air into the greenhouse and inside hot air to escape. Fans may be provided to assist in this air exchange. Roof vents in particular can be configured to open small or large portions of the roof. A shading system may be provided for the roof and walls (either on inside or outside) that during the day control incoming solar radiation from entering the greenhouse. The shading system may also serve as thermal barriers when installed inside a structure, and as such may be used at night to reduce heat loss out of the greenhouse when the outside is cooler than the inside. Typical shades are made of a porous fabric that allow for some limited air flow through the fabric. Other cooling systems include fog systems that include high pressure pumps that are used to distribute a fine mist of high pressure water (often in excess of 1000 psi) via a plurality of very small nozzles. The water molecules tend to vaporize and absorb some of the heat inside the greenhouse, but will fall to the ground and increase relative humidity (RH). Therefore, fog systems are best used for temporary cooling.

Another important consideration for greenhouse design is the control of the RH within the greenhouse. The RH inside a greenhouse usually builds up during the night while the plants are transpiring, and by evaporation of any liquid water that is left on the floor during the day from irrigation cycles, fog cooling, etc. Overly high RH will prevent a plant from cooling itself adequately, while an overly low RH will cause the plant to dry out. Therefore, precise control of the RH in a greenhouse is important to prevent the plants within from suffering.

Typically, greenhouse operators vent the greenhouse early in the morning, e.g. by opening roof vents, to reduce the RH that has built up inside the greenhouse over the night. Also, exhaust fans typically used for cooling can be turned on to increase the air exchange rate into and out of the greenhouse. When internal RH is lower than desired, systems typically used for cooling can be activated to increase the RH, e.g. by turning on the fog mist system and/or pad cooling system, provided that appropriate conditions exist for such operation. Many of these known humidity controlling techniques require the exchange of outside and inside air; if the RH or the temperature of the outside air is not at an appropriate level, then such techniques are less effective, or even dangerous to the health of the plant. For example, venting moisture from a greenhouse on a cold damp day may not appreciably reduce the RH inside the greenhouse, may cause a dramatic temperature change-related shock to the plants, and may increase operating costs by requiring additional heat to be supplied to warm the greenhouse back to its pre-venting temperature.

Other factors that are considered in greenhouse design include plant irrigation and carbon dioxide supply. It has been long recognized that elevated levels of CO₂ enhances crop growth, and as such, growers try to maintain CO₂ levels at higher than ambient conditions inside the greenhouse. Typically, CO₂ introduced into the greenhouses is produced by one or more of open air natural gas or propane burners, flue gas recovery systems, or supplied from liquid CO₂ tanks. If CO₂ is introduced via a combustion process, unwanted water, carbon monoxide and nitrous oxides are typically also introduced with the CO₂ into the greenhouse. CO₂ is typically introduced into the greenhouse during the day. Unfortunately, other climate control techniques used during the day compromise the effectiveness of CO₂ injection. For example, periodic venting of moisture from the greenhouse tends to also vent a substantial amount of the injected CO₂.

Various factors must be controlled to maintain an ideal environment for plant growth. The traditional methods and systems for controlling one factor are often not compatible with controlling another factor, and thereby results in high operating costs and reduced plant growth. A typical day and night cycle illustrates the difficulty of controlling such factors. During the night, plants give off moisture and CO₂. By the end of the night, the RH and CO₂ will tend to be relatively high. As the sun rises, and the plants awaken to their day cycle, they require moisture which is provided to them by the greenhouse irrigation system, which further raises the RH inside the greenhouse. The RH must be reduced quickly to avoid damaging the plants. Air exchange methods are thus undertaken to replace the RH-heavy greenhouse air with lower RH outside air. As the internal air is discharged, accumulated CO₂that would be usefully used during the day is also flushed out of the greenhouse. The vents are often left open for extended periods to cool and reduce the moisture content inside the greenhouse, forcing the operator to pump a relatively high amount of CO₂ into the greenhouse to compensate for the amounts lost by venting. As the sun falls and evening sets in, venting may also occur to lower the RH prior to nightfall. Such venting often prevents the use of the greenhouse's shading system that would normally be used for heat retention. Heaters must therefore be run at a relatively high level to compensate for the heat lost by venting.

### SUMMARY OF THE INVENTION

According to one aspect of the invention, there is provided an air processing unit for a greenhouse comprising:

(a) an air processing conduit having an inlet for receiving return air from inside a greenhouse, an outlet for discharging processed supply air, and an air flow path extending from the inlet to the outlet and in which the return air is processed into supply air,

(b) a heat sink in the air flow path operable to extract heat and condense water from return air flowing through the air flow path;

(c) an exterior heat rejector outside the air flow path and capable of thermally coupling to the heat sink such that heat removed from the air flow path by the heat sink is discharged from the air processing unit by the exterior heat rejector;

(d) an interior heat source inside the air flow path and capable of thermally coupling to the heat sink such that heat removed from the air flow path by the heat sink is returned back to the air flow path by the interior heat source;

(e) means for thermally coupling the heat sink to the exterior heat rejector during a cooling cycle, and to the interior heat source during a heating cycle; and

(f) a supply air distribution array fluidly coupled to the air processing conduit outlet and located inside the greenhouse in the vicinity of a crop grown inside the greenhouse, for discharging the supply air into the foliage area of the crops.

The heat sink may be an evaporator, the external heat rejector and internal heat source may be condensers, the thermal coupling means may be a diverting valve, and the evaporator, external condenser, internal condenser and diverting valve may be fluidly coupled to a refrigerant recirculation loop. The air processing unit may further comprise a compressor that is coupled to the loop downstream of the evaporator and operable to compress a refrigerant that has absorbed heat from the evaporator, thereby enabling the absorbed heat to be discharged from the refrigerant through one of the external and internal condensers.

The air processing unit may further comprise one or more of a carbon dioxide injector located in the air flow path and fluidly connectable to a carbon dioxide source, an oxygen injector located in the air flow path and fluidly connectable to a oxygen source, and, a nitrogen injector located in the air flow path and fluidly connectable to a nitrogen source. The air processing unit may also include a humidifier located in the air flow path and that is fluidly connectable to a water source.

The air processing unit may further comprise a return air duct fluidly coupled to the air processing conduit inlet, and having an inlet in fluid communication with the inside of a greenhouse. The return air duct inlet may be located above the canopy of a crop grown in the greenhouse.

The air distribution array may include a manifold that is in fluid communication with the air processing conduit outlet, and at least one elongated perforated distribution tube that is fluidly coupled to the manifold, whereby supply air is discharged through the perforations. The air distribution array may further comprise a frame supporting the distribution tube at selectable heights between the ground of the greenhouse and the canopy of the crop. In this connection, there may be a flexible interconnect tube that flexibly couples the manifold to the air processing conduit outlet thereby enabling the height of the manifold and distribution tubes to be changed relative to the air processing conduit outlet.

The distribution array may comprise a plurality of distribution tubes extending longitudinally from the manifold in a substantially parallel spaced configuration. The perforations may be positioned on the distribution tubes such that the discharged supply air creates a substantially horizontal, crisscrossing air flow pattern in the vicinity of the crops.

According to another aspect of the invention, there is provided a method of heating and dehumidifying a greenhouse, comprising:

(a) obtaining air from the inside of a greenhouse, the air including water vapour transpired by a crop grown inside the greenhouse;

(b) cooling and dehumidifying the air, thereby extracting sensible heat and water from the air, and latent heat from the condensation of the water vapour;

(c) converting the latent heat into sensible heat, and returning the converted and extracted sensible heat back into the air;

(d) discharging the heated and dehumidified air back into the greenhouse in the vicinity of the crops,

thereby reducing the need for greenhouse venting to control the humidity inside the greenhouse, and reducing the heat lost as a result of such venting.

The air may be obtained from a location inside the greenhouse above the canopy of the crop, and in particular, below a roof shade system and gutter level of the greenhouse. The heated and dehumidified air may be discharged from a plurality of air flows in the vicinity of the crops. In particular, the heated and dehumidified air may be discharged from a plurality of substantially horizontal air flows, thereby creating a crisscrossing pattern of air flows in the vicinity of the crops. These substantially horizontal air flows may be located at a height in the vicinity of the crop canopy height.

This method in effect, harnesses plants as a heat source. That is, plants absorb nutrients via water intake with the use of its root system. The excess liquid water is stored within the plants cell structure for partial usage during the day time when cooling is required. When a plant requires cooling, it transpires water vapour. The plant expends energy to convert the stored liquid water to vapour. The water vapor released by the plant for cooling contains considerable latent heat energy, about 2250 J/g of moisture. It is this latent heat that is converted to sensible heat by the above method and used to heat air in the greenhouse.

The rate of moisture transferred from the leaf to the surrounding air is dependant upon the difference in the partial pressure of water vapor in the leaf stomates versus the surrounding air. Therefore, if the surrounding air has too high relative humidity, the plant has difficulty in releasing energy to the environment. But the holding capacity of the air for moisture is dependant upon its temperature. Therefore, in warm areas of a greenhouse the relative humidity will be lower than cooler areas, even though the amount of water vapor per unit of air is the same. Therefore, by discharging warm dehumidified air into the crops according to the above method, transpiration of the crops is improved, thereby improving crop health.

Our method removes moisture from the air, converts the latent heat into sensible heat, and reintroduces the heat back into the air stream. Should the greenhouse not require heated air, the heat may be: transferred directly into heating of other areas of the facility such as soil heating, heating of adjoining areas or heating of irrigation water; transferred into storage facilities (e.g. insulated water tanks) for later use; or wasted to the outside atmosphere.

According to another aspect of the invention, there is provided a method of heating and dehumidifying a greenhouse, comprising:

(a) obtaining air from the inside of a greenhouse above the canopy of a crop grown inside the greenhouse, the air including latent heat in water vapour transpired by the crop;

(b) cooling and dehumidifying the air, thereby extracting sensible heat and water from the return air, and latent heat from the condensation of the water vapour;

(c) converting the latent heat into sensible heat, and returning the converted and extracted sensible heat back into the air;

(d) discharging the heated and dehumidified air back into the greenhouse in the vicinity of the crops thereby creating a localized moving layer of warm air that envelopes the crops,

thereby reducing the frequency of greenhouse venting to control the humidity inside the greenhouse, and the heat lost as a result of such venting. The creation of the warm air layer creates a layer of colder air above the crop canopy and near the peak of the greenhouse.

This method relates to creating an air flow system within the greenhouse, that effectively reduces the heat loss of the greenhouse. A significant amount of the heat lost in a greenhouse is by conduction through the cladding of the greenhouse. The rate of the conductive heat lost is primarily dependant upon the heat transfer co- efficiencies of the cladding material and the temperature differentials between the outside and inside.

It has been found that by circulating the air within part of the greenhouse, the load used to heat the greenhouse can be appreciable reduced. This air circulation creates a localized layer of moving warm air, or “micro air climate”, in a selected part of the greenhouse, e.g. around the crops, by drawing warm moisture-laden air from above the crop canopy, and below the shade system and below the gutter level of the greenhouse. As a result, the air above the micro-air climate is not a part of the moving air stream, and thus is basically stagnant, i.e., there is little or no air disturbance within the upper areas of the greenhouse.

It is believed that the creation of a micro-air climate is directly related to a reduced heating load on the greenhouse. The above method takes advantage of the fact that with the controlled air flow patterns created in the warm air layer, an area of little air flow occurs within the upper areas of the greenhouse. As there is minimal air flow within the upper areas of the greenhouse, very little heat transfer occurs. It has been found that around the inner layer of the exterior cladding, the air temperature is very close to the outside air temperature. In other words, a layer of colder air adjacent to the cladding serves as an insulating buffer from conductive heat loss through the cladding.

### BRIEF DESCRIPTION OF THE DRAWINGS

FIG. 1 is a schematic plan view of a climate control system installed in a greenhouse.

FIG. 2 is a schematic side elevation view of the climate control system and greenhouse shown in FIG. 1.

FIG. 3 is a schematic south elevation view of the climate control system and greenhouse shown in FIG. 1.

FIG. 4 is a schematic north elevation view of the climate control system and greenhouse shown in FIG. 1.

FIG. 5 is a schematic plan view of an air processing unit and some ducting and supply air distribution tubes of the climate control system.

FIGS. 6(a) and (b) are schematic side elevation views of components of the climate control system, and in particular, of flexible supply air ducting and movable distribution tubes located at lowered (FIG. 6(a)) and raised (FIG. 6(b)) positions inside the greenhouse.

FIG. 7 is a schematic refrigerant piping diagram of the air processing unit.

FIG. 8 is a schematic control diagram for a controller of the air processing unit.

FIG. 9 is a flow chart of the control strategies used by the controller when operating the air processing unit.

FIGS. 10(a) to (i) are schematic end elevation views of supply air distribution tubes each having a different air discharge aperture pattern.

FIGS. 11(a) to 11(c) are schematic elevation views of supported distribution tubes being moved upwards with the growth of a cut flower crop.

FIG. 12 is a schematic plan view of the supported distribution tubes of FIGS. 11(a) to (c).

FIG. 13 is a schematic perspective view of supported distribution tubes used in growing a vegetable crop.

FIGS. 14 (a) to (c) are schematic elevation views of various supported distribution tube layouts for growing a vegetable crop.

FIG. 15 is a schematic perspective view of a distribution tube used in growing reforestation crops.

FIG. 16 is a schematic perspective view of overhead distribution tubes mounted inside a greenhouse.

FIG. 17 is a schematic view of a chilled water recirculation loop according to an alternative embodiment of the invention.

### DETAILED DESCRIPTION OF EMBODIMENTS OF THE INVENTOIN

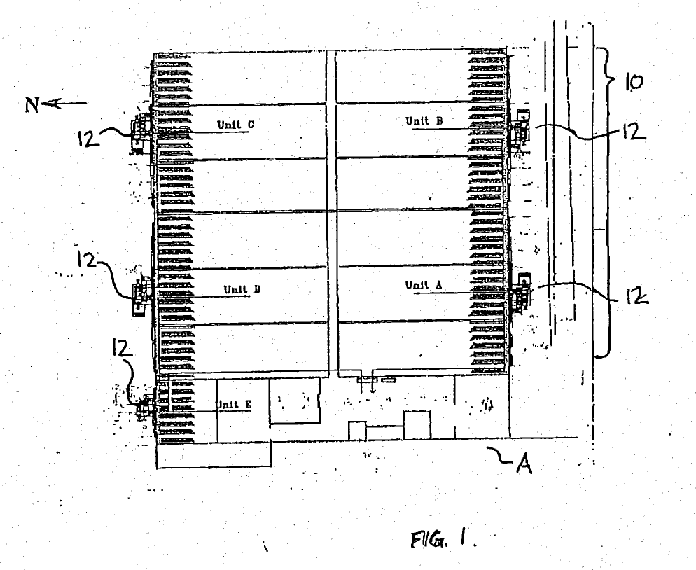

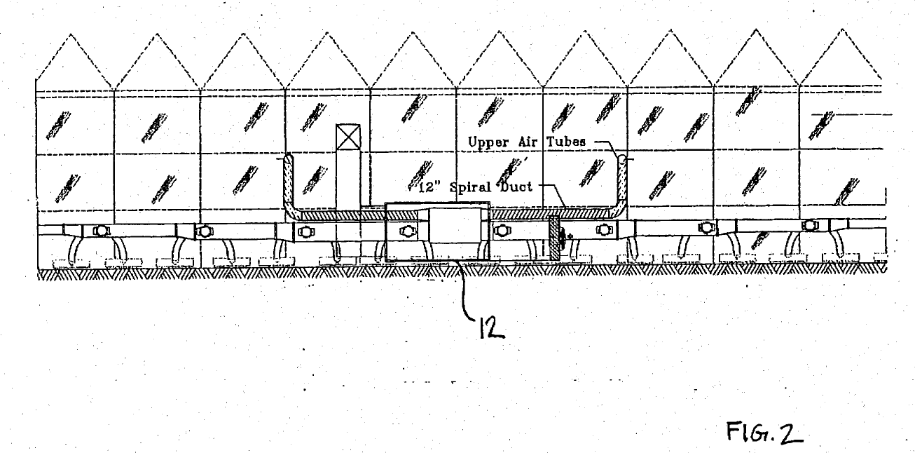

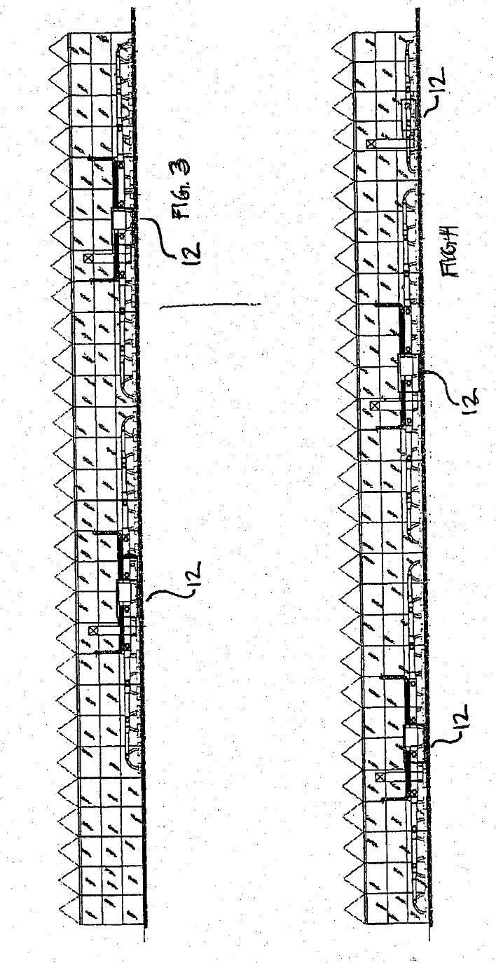

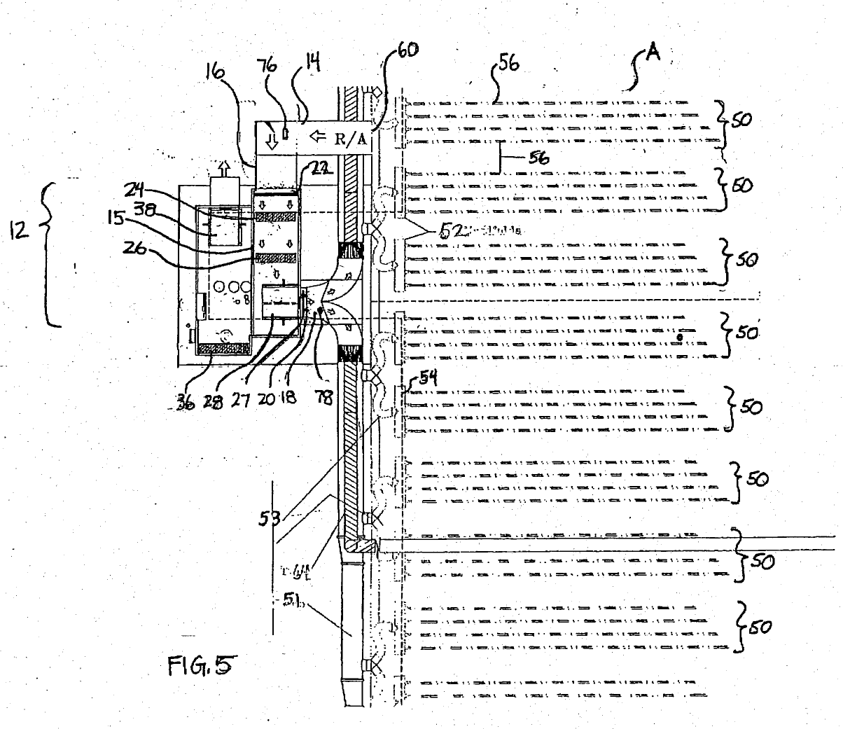

Referring to FIGS. 1 to 4 and according to one embodiment of the invention, there is provided a greenhouse climate control system 10 for controlling the- air exchange rate, temperature, and relative humidity (RH) level in a greenhouse A.

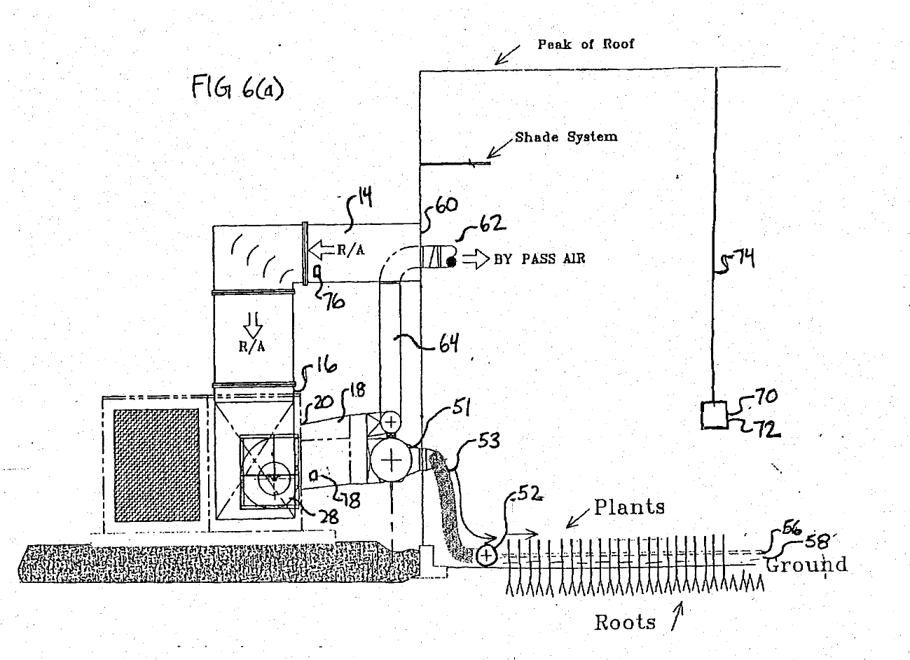

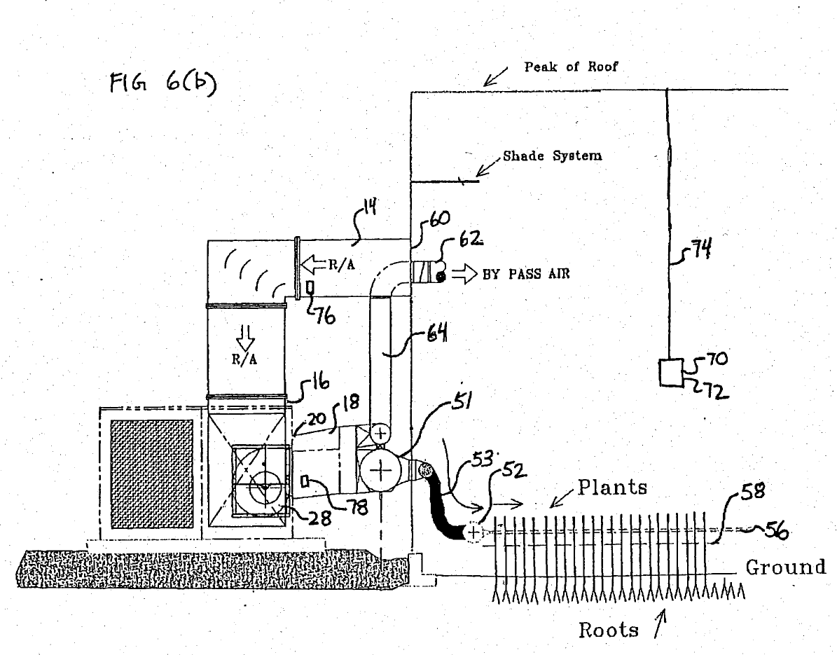

The system 10 has at least one air processing unit 12 that obtains return air from the greenhouse A, processes the air, and returns the processed air as supply air back into the greenhouse A. FIG. 1 illustrates a greenhouse A having five air processing units 12 for processing and supplying air into five zones of the greenhouse A. Referring to FIGS. 5 and 6, each air processing unit 12 includes a return air duct 14 that has one end in fluid communication with the greenhouse A, and another end connected to an inlet 16 of an air processing conduit 15. Each processing unit 12 also has a supply air duct 18 with one end connected to an outlet 20 of the air processing conduit 15, and another end in fluid communication with the greenhouse A via an air distribution array 50. The return air duct 14, air processing conduit 15 and supply air duct 18 define an air flow path through the unit 12. The air processing conduit 15 is preferably fluidly sealed to prevent or at least significantly impede greenhouse air from escaping from the air flow path. Inside the air processing conduit 15 are a number of components in the air flow path, for processing the return air, including: air filters 22, evaporator coils 24, internal condenser coils (“reheat coils”) 26, humidifier water jets 27, and an internal fan 28.

The filters 22 are mounted near the inlet 16 and per se are of a conventional design. The filters 22 may be, for example, disposable fibre filters commonly used in the HVAC industry. The filters 22 serve to remove unwanted particulates in the return air.

The evaporator coils 24 are located downstream of the filters 22 and serve to cool and dehumidify the return air. The evaporator coils 24 are made from thin copper tubing and have an inlet and an outlet for the inflow and outflow of R-22 freon refrigerant; however, any suitable refrigerant fluid as known in the art may be substituted. The coil pattern can be based on one of many known heat exchanger coil designs in the refrigeration industry. The evaporator coils 24 are preferably made of copper but may be made with any material having a suitably high degree of thermal conductivity.

Referring to FIG. 7, the evaporator coils 24 are fluidly connected at its inlet and outlet to condenser coils 26, 36 to form a closed refrigerant recirculation loop. A compressor 32 is connected to the recirculation loop downstream of the evaporator coils 24 and upstream of the condenser coils 26, 36 as is known in the art. A thermal expansion valve 34 is connected downstream of the condenser coils 26, 36 and upstream of the evaporator coils 24 as is also known in the art.

The condenser coils include external condenser coils 36 as well as the reheat coils 26. The external condenser coils 36 are located outside the air processing conduit 15, and inside an external air duct 35. The external air duct 35 has an air inlet and outlet. An external fan 38 is located inside the external air duct 35 for moving outdoor air through the external air duct 35 via the inlet and outlet. The reheat coils 26 are located inside the air processing conduit 15 downstream of the evaporator coils 24. A diversion valve 40 is located downstream of the compressor 32 and is operable to direct the flow of refrigerant to one of the reheat coils 24 or external condenser coils 36. Check valves 42, 44 are connected to the recirculation loop downstream of respective reheat coils 26 and external condenser coils 36 to prevent backflow of refrigerant into the condenser coils 26, 36. A refrigerant receiver tank 46 is connected to the recirculation loop downstream of the check valves 42, 44 and upstream of the thermal expansion valve 34 to store liquid refrigerant awaiting flow through the evaporation coils 24.

While FIG. 7 shows a single recirculation loop, the air processing unit 12 can have multiple recirculation loops. The air processing unit shown in FIGS. 5 and 6 feature three recirculation loops, to provide three separate stages of control over the air processing. A different number of recirculation loops may be provided depending on the needs of the greenhouse operator. In this embodiment, three compressors 32 are separately controllable and one or more can be activated depending on air processing needs (the compressors used in this embodiment are of the on/off type and cannot be modulated). The evaporator coils 24 of each recirculation loop may be interlaced. Similarly, the reheat coils 26 and external condenser coils 36 of each recirculation loop amy be respectively interlaced.

Instead of using R22-freon refrigerant coupled to compressors, evaporator coils, and condenser coils and according to another embodiment of the invention, cold water (with or without antifreeze solutions) is used for cooling and dehumidification and hot or modulated (temperature controlled) water is used for heating. Such a cold water system is shown in FIG. 17. In this connection, cold water is flowed through evaporator-type coils and hot or temperature-controlled water is flowed through reheat-type coils. This alternate method of cooling and heating the air can be particularly helpful in a system having multiple air processing units, and limited space for the equipment, and also in a system where it is desirable to provide heat by heated supply air and by radiant heating type hot water bench heating tubes. Cold water can be provided from a stable cold source such as ground water or from a compressor/chiller system. Hot water can be procured from a compressor/chiller system or from conventional systems such as boilers.

Referring again to FIGS. 5 and 6, the humidifier 27 is located in the air flow path and serves to introduce water into the supply air stream. For example, if the evaporator coils 24 have lowered the RH of the greenhouse air stream below a desired level, or the return air is low in RH (e.g. during high solar periods when internal air temperatures rise), water can be introduced into the a r stream by the humidifier 27, which may suitably be a series of water jets that are controllable to emit a fine spray of water into the air stream. The humidifier 27 has an injection port that is fluidly connected to a water supply (not shown). The injection of water into the air path also serves to provide additional cooling of the air when ambient conditions require it.

Optionally, heating coils (not shown) may be provided in the air flow path to provide additional heat to the air stream. The heating coils are a heat exchanger and are constructed similarly to the evaporator coils 24 and the reheat coils 26. Heated water is transmittable through the heating coil via a heated water inflow conduit fluidly connected to an inlet of the heating coil, and a heated water return conduit fluidly connected to an outlet of the heating coil. On occasions requiring heating of the greenhouse air, the heating coil is activated by flowing hot water through the heating coil so that heat from the heating water can be transferred to the greenhouse air stream.

Optionally, CO2 can be introduced into the air stream by one or more CO₂ injectors (not shown) located downstream of the heating coils. The CO₂ injectors have an injection port which is fluidly connected to a liquid CO₂ supply (not shown), and the liquid CO2 is turned into a vapor with control devices which are common within the CO2 supply industry. The CO₂ supply may also be a propane or a natural gas burner located adjacent to the unit 12. When this process is used, the CO2 injection would take place directly into the greenhouse, or on the suction side of the system internal fan 28.

Should a specific crop require addition of other compounds such as oxygen (O₂) or nitrogen (N) so as to enrich the growing environment for the plants, the direct injection of these can be done according to a similar manner as explained for CO₂.

In operation, the internal fan 28 is operated to move air from the greenhouse A, through the return air duct 14, processing air conduit 15, supply air duct 18, and back into the greenhouse A. In a cooling and dehumidification cycle, all three of the recirculation loops may be activated; in each recirculation loop, the diversion valve 40 is set to flow refrigerant through the external condenser coils 36 and bypass the reheat coils 26. Warm and humid greenhouse return air passes by the evaporator coils 24, and heat is transferred from the air to the refrigerant flowing through the evaporator coils 24, thereby lowering the temperature of the air. As the air cools, its RH will reach 100% and the air will reach its dew point and will not be able to hold any more water; as the air is cooled further, some of the water vapour will condense inside the unit 12 and particularly on the evaporator coils 24. The air is thus cooled and dehumidified and returned to the greenhouse as supply air. (Note that even though there has been a net amount of water removed from the air stream, the supply air likely is at 100%RH as it is cooler than the return air and therefore has less capacity to hold water) The condensed water is drained from the unit 12 through a drain (not shown) at the bottom of the unit 12. The recovered water can then be stored for reuse by other systems, such as the irrigation and fog systems.

As is well known in the art, cold low-pressure liquid refrigerant flows through the evaporator coils 24 and is warmed and vaporized when it absorbs heat from the return air. The warmed gaseous refrigerant is then compressed by the compressor 32 into a hot, high pressure gas, and then is flowed through the external condenser coils 36 wherein it releases heat and condenses into a liquid. The liquid refrigerant then passes through the expansion valve 34, evaporates into a cold low pressure gas and returns to the evaporator coils 24, thereby completing the recirculation loop. The released heat is discharged into the atmosphere via the outdoor air duct 35.

In a dehumidification only cycle or in a dehumidification and warming cycle, the diversion valve 40 is set so that refrigerant flows through the reheat coils 26 and the external condenser 36 is bypassed. In operation, at least some of the sensible heat of the greenhouse air and some of the latent heat in the condensation of water are absorbed by the refrigerant and returned back into the greenhouse air stream by conduction through the reheat coils 26.

Referring again to FIGS. 5 and 6, air is removed from the greenhouse from the return air duct 14, is processed by the unit 12, and is returned as supply air to the greenhouse A. The return air duct has an inlet 60 that is mounted in the greenhouse wall at a height above the crops and below a shade system and gutter line of the greenhouse. The position of the return air duct is selected to capture as much rising warm air as possible, thereby minimizing the amount heat lost by conduction through the greenhouse ceiling from warm air that has risen to the ceiling.

Optionally, a bypass damper (not shown) may be located in the process air conduit 15 in the vicinity of the evaporator coils 24 that when opened, enables air to flow there through and bypass the evaporator coils 24; such bypass may be desirable, for example, if the greenhouse air is to be heated without dehumidification. The bypass damper also allows for the volume of air to be balanced between the evaporator coils 24 and the bypass. This is useful when the return air is higher in temperature than desired; this higher air temperature coupled with the normal air volume could be outside of the normal operating perimeters of the evaporator coil and compressor combination. When this situation occurs, critical refrigerant pressure balance may be affected, and by changing the air flow characteristics across the coil, the refrigerant pressure balance can be maintained in the system.

The supply air is discharged through the supply air ducting 18 and into the greenhouse A through the supply air distribution array 50. The distribution array 50 is located inside and along the floor at one end of the greenhouse. The distribution array 50 is a series of branching tubes that distribute air from a main supply tube 51 to a plurality of branch tube manifolds 52. A plurality of flexible interconnect tubes 53 each connect a branch tube manifold 52 to the main supply tube 51. An air damper (not shown) may be provided at each branching point to balance the air flow between each of the downstream branches; such air dampers are conventional devices known in the HVAC industry to serve such a purpose.

Each branch tube manifold 52 comprises a plurality of supply air outlet outlets 54. Each branch tube outlet 54 is connected to a micro-air distribution tube 56 that has a plurality of small apertures 57 along its length to discharge processed supply air back into the foliage of the crop or into the greenhouse. The selected aperture size depends on the type of crop being grown; typical aperture sizes can vary from 1/32″ to 1″ diameter. A plurality of micro-air distribution tubes 56 are shown in FIG. 5 as extending from one end of the greenhouse in a parallel, horizontal configuration. In the greenhouse shown in this embodiment, there are five air processing units 12 distributed along the north and south walls of the greenhouse, each with micro-air distribution tubes 56 extending from one of the greenhouse walls and terminating near the center of the greenhouse. However, it is within the scope of the invention to position the micro-air distribution tubes 56 in other configurations, which may depend on factors such as the number of air processing units 12 and the layout of the greenhouse in which the system 10 is installed.

The micro-air distribution tubes 56 are normally made from a clear polyethylene tube and can be of various outside dimensions. The dimension of the micro-air tube 56 is dependant upon the volume of air to be moved, its length and the area to which it is be installed. Referring to FIGS. 10(a) to 10(i), the apertures 57 for each micro-air distribution tube 56 may be located at different positions along the tube 56. Examining the tubes 56 from its proximal end and referencing the positions of the apertures 57 according to hour clock positions, the apertures 57 may be located in a single row such as “12 O'clock” position (FIG. 10(a)), “7 O'clock” (FIG. 10(b)), “3 O'clock” (FIG. 10(c)) and “5 O'clock” (FIG. 10(d)); in a pair of rows such as “3” and 9 O'clock” (FIG. 10(e), “4 and 8 O'clock” (FIG. 10(f), and “1 and 11 O'clock” (FIG. 10(g)), or in four rows such as “2:45, 3:15, 8:45 and 9:15 O'clock” (FIG. 10(h)), and “2:30, 3:30, 8:30 and 9:30 O'clock” (FIG. 10(i)).

The preferred pattern of apertures 57 depend on the crop being grown and may be varied; an operator will select a particular aperture pattern so that as much as possible, a constant air flow is provided to each individual plant foliage. It has been found that an aperture pattern that provides a horizontal crisscrossing air pattern is particularly beneficial to crop growth. In each of these configurations, the apertures 57 discharge supply air at a rate that provides a gentle breeze-like effect of multiple small air currents that causes the crops to move slightly. This movement is believed to increase the mechanical strength of the crop stems, thereby improving the crop's commercial value. It is believed that the gentle continuous movement of the plants in effect “exercises” the plants, causing the plant to transport calcium to the stem thereby improving its mechanical strength.

The determination of number, size and distribution of apertures 57 in each distribution tube 56 is based upon the type and density of crop grown, total air volume of the greenhouse A, and the foliage density and the amount of individual air streams the greenhouse operator desires to create. In particular, the total area of the apertures should not exceed the total cross sectional area of the distribution tube 56. Another factor to be considered in selecting the orientation, size and number of apertures 57 is the creation of a balanced air flow pattern; balancing the air flow within each distribution tube 56, in relation to the apertures 57 within it, is achieved by striking a critical balance between the velocity pressure and resulting static pressure within the tube 56 at each of the individual aperture 57. That is, the characteristics of each of the apertures 57 are selected to provide equal air flows, so that the volume of air discharged from the tube 56 creates slightly more static pressure than the static pressure created at each of the individual aperture 57.

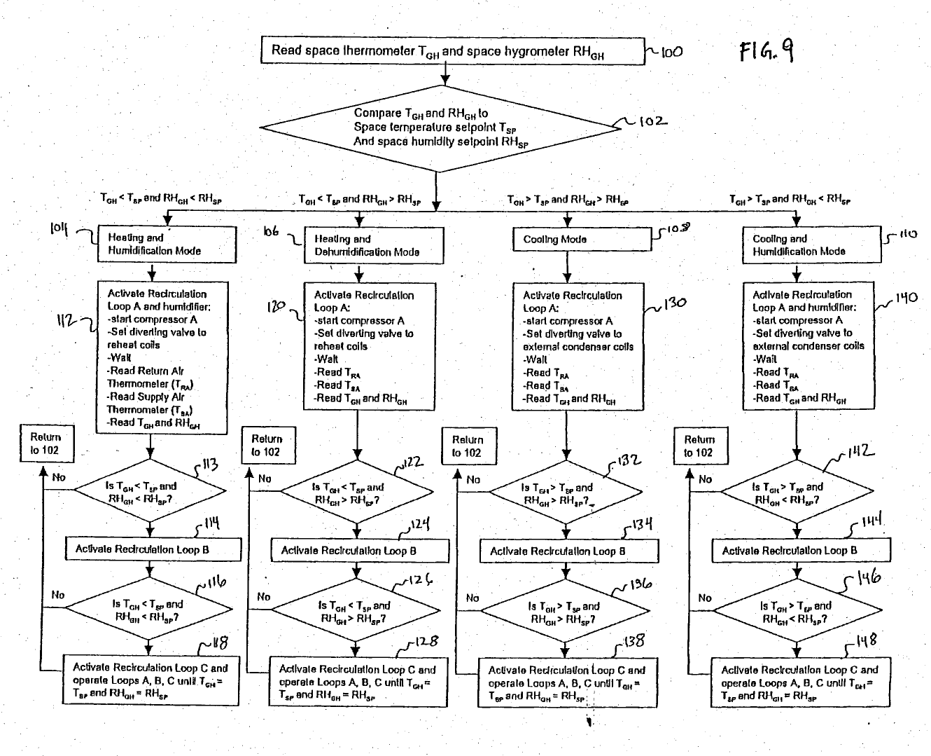

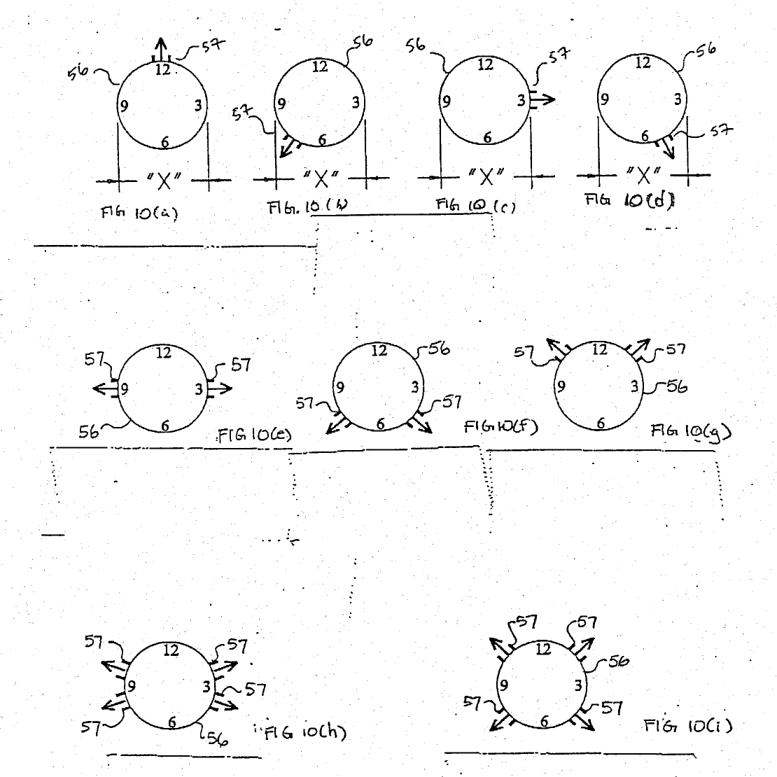

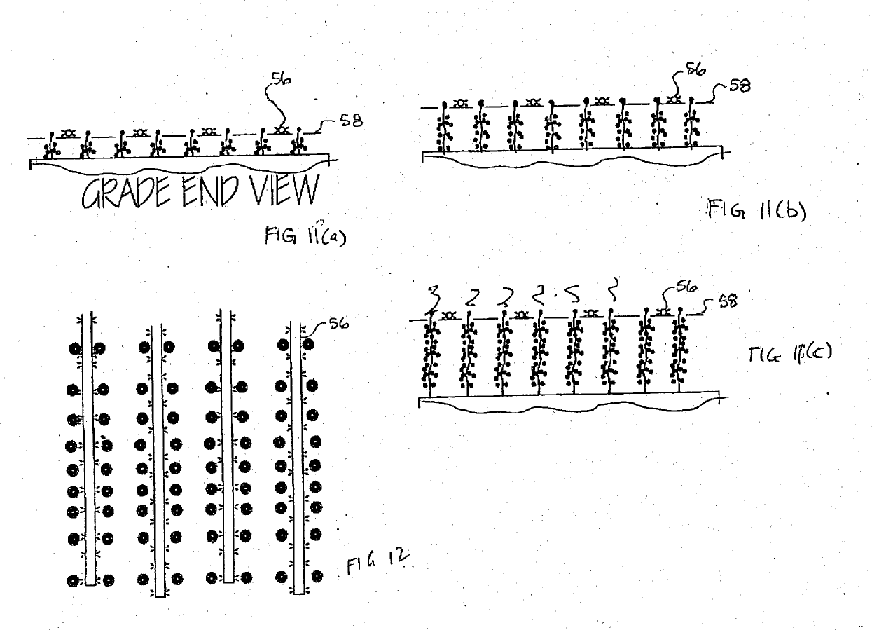

Referring particularly to FIGS. 6, 11 and 12, the distribution tubes are mounted on moveable supports 58. The supports 58 are suitably an elongated framed mesh laid horizontally over the ground of the greenhouse A. A crop such as cut flowers extend in parallel rows along the ground and upwards through the mesh. The distribution tubes 50 are laid on the mesh in between the crop rows. The supports 58 can be raised relative to the ground; this enables the micro-air distribution tubes 56 to be optimally positioned relative to the crop at all times during crop growth. For example, for cut flowers, it is desirable to position the micro-air distribution tubes 56 between 6″ and 12″ below the top of the plant. Therefore, as the flowers grow, the supports 58 are raised so that the micro-air distribution tubes 56 are maintained at an appropriate height. Flexible tubes 53 enable the distribution tubes 56 and branch tube manifolds 52 to remain connected to the rest of the air processing unit 12 when raised with the supports 58.

When the system is used in a crop such as cut flowers, and when the individual plants are grown in the ground, the individual growing beds have to be replanted after each growing cycle is complete. In order for the grower to replant a crop within the area, it is necessary for the ground to be prepared by tilling the ground and also for the ground to be sterilized by a steam or other process common to the grower. Due to this fact, it is necessary for the micro-air tubes 56, and the manifolds 52 to which they are attached to be raised out of the path of the work to be performed. Each of the manifolds are supplied with a curved ring to which a upper support hook can be attached (not shown), and the individual micro-air tubes 56 can also be suspended overhead with the usage of hooks. The combination of hooks, allows for the manifolds 52 and micro air tubes 56 to be raised completely out of the way, so that the necessary ground preparation work can be performed.

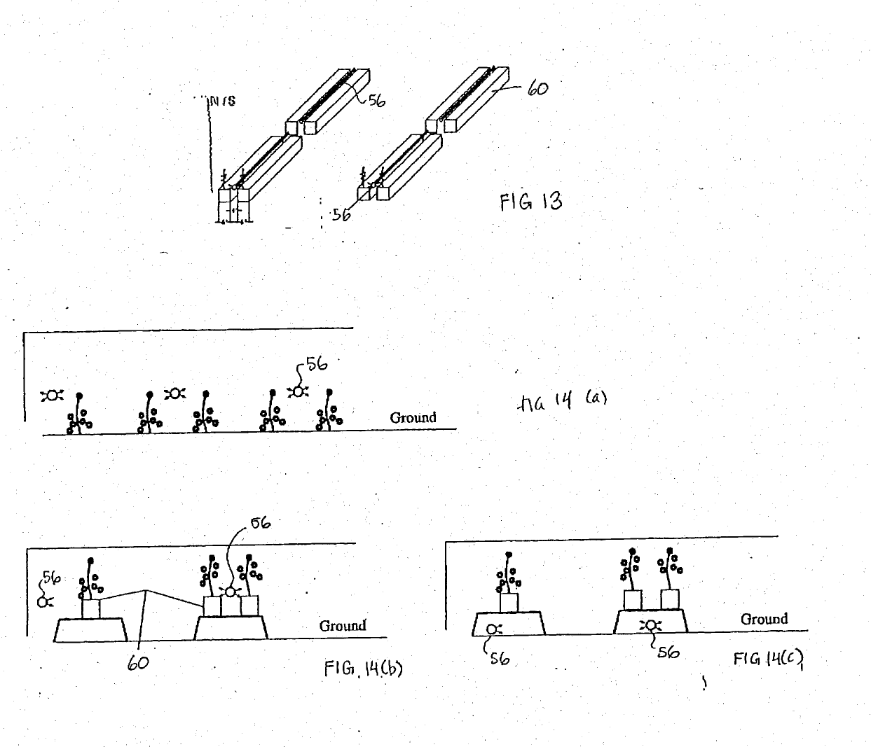

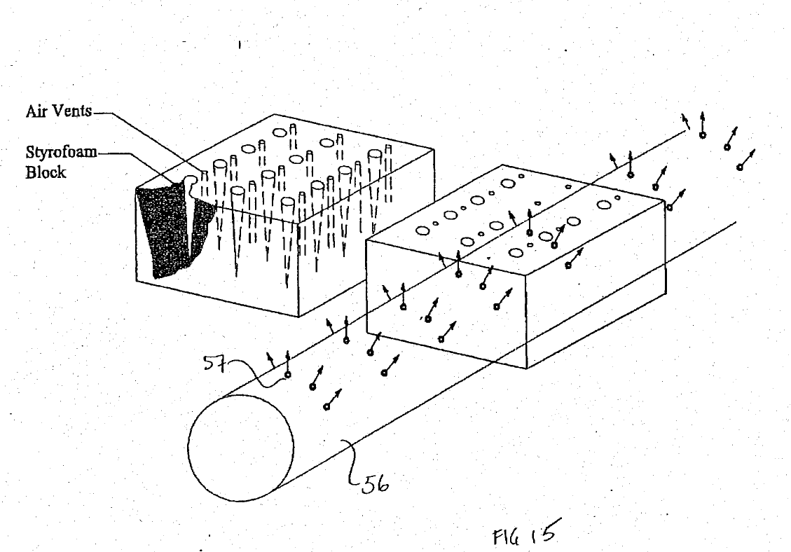

According to another embodiment of the invention, and referring to FIGS. 13 and 14, the micro-air distribution tubes 56 are configured to discharge supply air to a vegetable crop. In this connection, the micro-air distribution tubes 56 are positioned so that the micro-air tube sits directly on the edges of growing media bags 60, between the stalks of the plants. Alternatively, the vegetables may be planted directly in the ground (FIG. 14(a)) in which case the distribution tubes 56 are mounted directly between the plant stalks. When plants are grown directly in the ground, the micro-air distribution tube 56 would normally end up supported on its sides by the stalk of the plant, and that it would stay in place due to the friction-like support offered by the plant stalks. Should the plant spacing be wider than normal, the micro-air distribution tube 56 could sit partially on the ground.

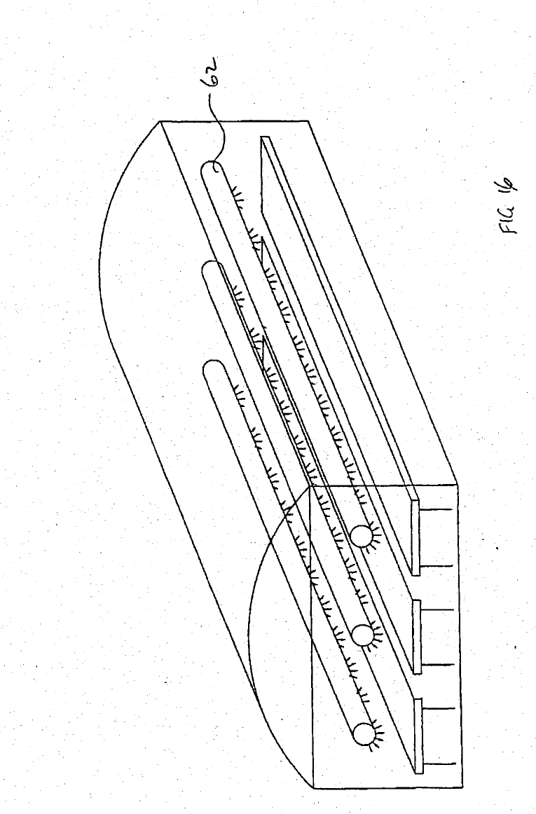

According to yet another embodiment of the invention, and referring to FIG. 15, the micro-air distribution tubes 56 are configured to discharge supply air to a reforestation crop. In this connection, the micro-air distribution tubes 56 are placed below styrofoam blocks or other growing container utilized in the growing of tree seedlings. The air discharged from the micro-air distribution tubes flows up through vent 10 holes within the crop-specific containers such as styrofoam blocks common to the industry.. As the air passes up through the vent holes, heat is conducted via conduction through the block into the larger cavities to which the soil and tree seedling is contained. In addition, the air passes directly through the tree seedling foliage and into the air directly above the crop, and then the air goes back to the air processing unit 12 to be reprocessed.

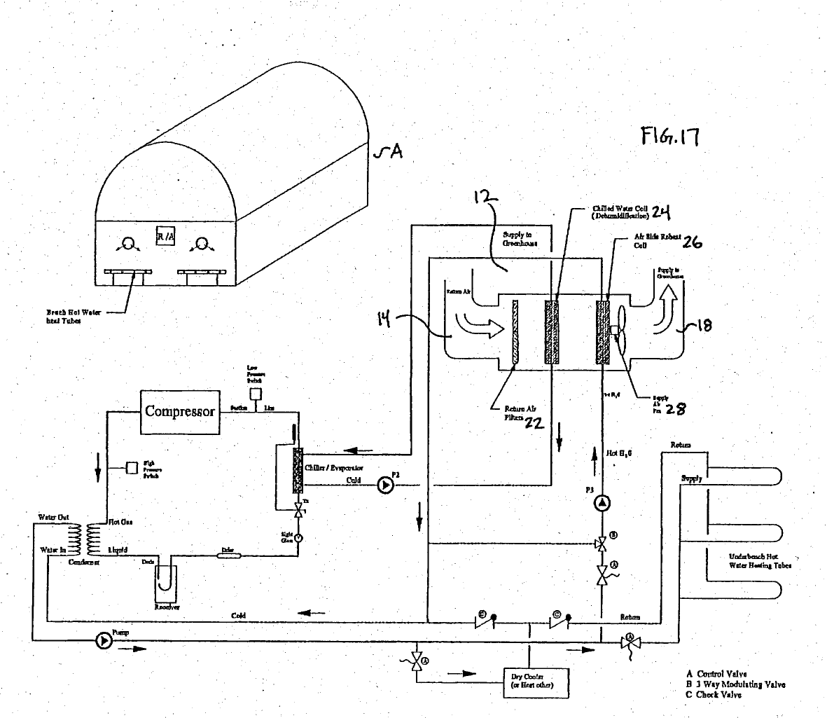

Optionally, additional micro-air distribution tubes 62 may be mounted above the greenhouse crops. Referring to FIGS. 5, 6 and 16, the tubes 62 are fluidly coupled to the supply air duct 18 via an overhead air tube 64. The purpose for installing such overhead supply air distribution tubes 62 is to allow for a constant micro air flow directly into the plants foliage. This is used in cases where the containers that the crop is grown in, do not allow for air flow through it, such as the various types of containers used in plug production or bedding plants.

Alternatively, hot water heating tubes that are conventionally used to heat the soil of the crop may be thermally coupled to the system 10, and in particular to one or more recirculation loops of the air processing unit 12. This provides for greater flexibility in creating not only the exact type of climate for the foliage, but also in utilizing the recovered heat in more effective ways. The system 10 when used in this manner, can dehumidify, cool, and reheat the air, plus provide heat into hot water distribution systems that are used for directly controlling the actual root temperatures of the crop. This is useful in crops where a high soil temperature and cooler air temperatures within the crops foliage are desired. This type of application is common in plug production, bedding plants and nursery production.

A number of sensors are installed in the air processing unit 12 and inside the greenhouse space to determine the greenhouse conditions and the operation of the processing unit. These sensors include one or more temperature sensors 70 and hygrometers 72 located in the greenhouse space (herein referred to as “space temperature sensors 70” and “space hygrometers 72”), and in particular, suspended by a chain 74 inside the greenhouse to about the canopy height of the crops. The chain 74 enables the height of the sensors 70, 72 to be adjusted, e.g. to maintain the sensors 70, 72 around the canopy height as the crop grows and its canopy height increases. The temperature sensor 70 is a thermistor type and the hygrometer 72 is an absorption substrate type both manufactured by Mamac.

Other sensors include a return air temperature sensor 76 located in the return air duct, and a supply air temperature sensor 78 located in the supply air duct. As can be seen in FIG. 7, a condenser refrigerant temperature sensor 80 is connected to each recirculation loop downstream of the reheat coils 26 and condenser coils 36 and upstream of the evaporator coils 24. Also, an evaporator refrigerant temperature sensor 82 is connected to each recirculation loop downstream of the compressor 32 and upstream of the diverting valve 40. The temperature sensors 76, 78, 80, 82 are a thermistor type manufactured by Mamac. Furthermore, a internal fan status sensor 84 and external fan status sensor 86 are located in the respective fans 28, 38 to monitor their operation. These fan status sensors 84, 86 are current transformers also manufactured by Mamac.

It is understood that any recognized industry standard compatible sensor may be substituted for the specific sensors mentioned above, as will occur to one skilled in the art.

Optionally, CO₂ sensors (not shown) can be located in the greenhouse space, return air duct 14 and supply air duct 18 to measure the CO₂ levels around the canopy level and inside the air processing unit 12, to provide information about whether CO₂ should be injected into the air stream by aforementioned optional CO₂ injectors. Furthermore, should the system 10 include oxygen (O₂) or nitrogen (N) injectors, the system 10 would include appropriate oxygen and nitrogen sensors (not shown).

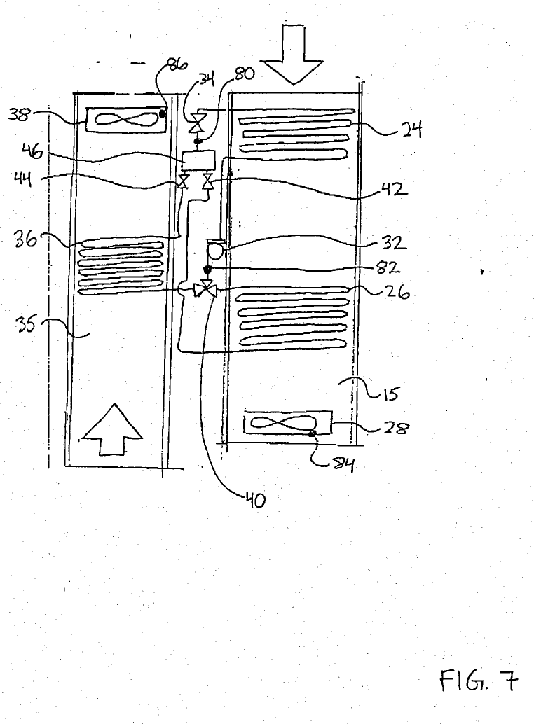

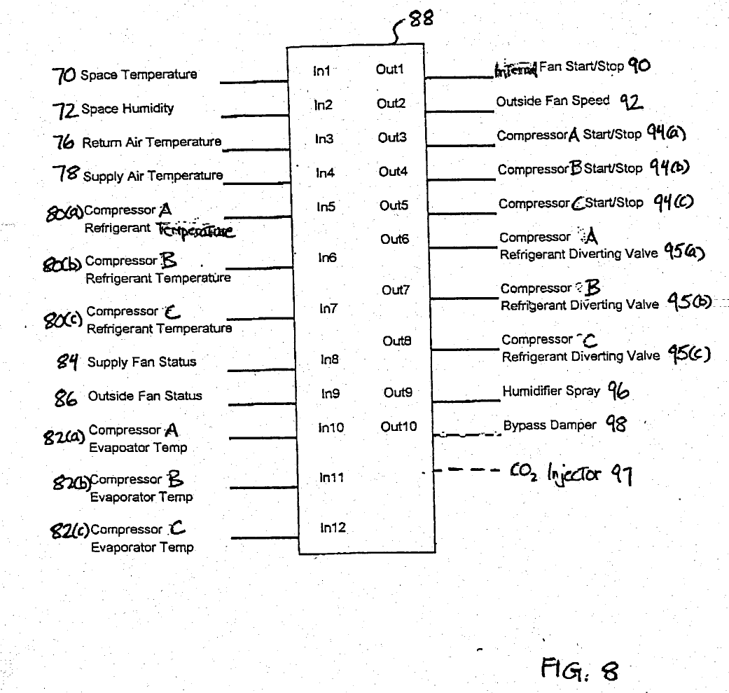

Referring now to FIG. 8, a controller 88 is programmed with a climate control program, and is communicatively linked to receive data signals from the sensors 70-86 and to send control signals to actuators in components of the air processing unit 12, namely actuators for controlling the operation of: the internal fan 28 (internal fan actuator 90), the outside fan 38 (outside fan actuator 92), each compressor 32 (compressor actuator 94(a), (b), (c)) in each recirculation loop, each diverting valve 40 in each recirculation loop (diverting valve actuator 95 (a), (b), (c)), and the humidifier spray 25 (humidifier actuator 96), and the optional CO₂ injector (CO₂ injector actuator 97), and the optional bypass damper (bypass damper 98). If O₂ and N sensors are provided, such sensors would also be communicative with the controller 88.

The controller 88 is a Mach 1/Mach Zone type controller combination manufactured and sold by Reliable Controls and is programmed using RC Studio with one or more reference climate profiles each relating to a particular crop. However, a person skilled in art will be able to substitute another suitable commercially available controller. For each crop's climate profile there is included a number of parameters such as preferred temperature range and RH range, for different times of the day, and for different seasons in the year. In particular, the controller 88 is programmed with multiple temperature and RH set-points; these set points are different at different times of day and season. At sunrise for a particular season, the temperature set-point ramps up from a night temperature set-point to a day temperature set-point over a set period (e.g. two hours); at sunset, the temperature set point ramps down over a set period from the day temperature set-point to the night temperature set-point. Typically, the RH set-point is consistent throughout the 24 hour period. The controller 88 is also programmed with the desired air exchange rate for the greenhouse A, and operates the internal fan 28 continuously at a speed sufficient to meet the desired air exchange rate.

The parameters in each reference profile are manually adjustable by an operator, enabling the operator to fine tune the reference profile to the particular plant he is growing; or, the operator may input his own parameters and create his own unique climate profile.

FIG. 9 illustrates the control strategies programmed into the controller 88 for controlling the operation of the air processing unit 12 to achieve the desired temperature and RH set-points. Referring to decision block 100, the controller 88 first reads temperature and RH data measured from the space temperature sensor 70 and hygrometer 72, and compares the readings to the temperature and RH set-points (block 102). When the temperature is less than the set-point and the RH is less than the set-point, then the controller enters a heating and humidification mode (block 104). When the temperature is less than the set-point and the RH is greater than the set-point, then 15 the controller 88 enters a heating and dehumidification mode (block 106). When the temperature is greater than the set-point and the RH is greater than the set-point, then the controller enters a cooling and dehumidification mode (block 108). When the temperature is greater than the set-point and the RH is less than the set-point, then the controller 88 enters a cooling and humidification mode (block 110).

In the heating and humidification mode 104, the controller 88 activates one of the recirculation loops (herein referred to as loop “A”), by starting up its compressor 32(A) and setting its diverting valve 40(A) to divert refrigerant to the reheat coils 26, and activating the humidifier spray 96 (block 112). Then, the controller waits for a selected period of time then reads the return air temperature, supply air temperature, space temperature, and space humidity from temperature sensors 70, 76 78 and hygrometer 72, then compares these readings with the temperature and RH set-points (block 112). If the space temperature and humidity both continue to be less than their respective set-points (block 113), then the controller 88 continues in the heating and humidification mode and proceeds to activate the second recirculation loop B (block 114). Then, the controller 88 waits another selected period and reads the aforementioned sensors again (block 116). If necessary, the controller 88 activates the third recirculation loop C (block 118). All three recirculation loops A, B, C are activated along with the humidifier spray 96 until the space temperature and humidity have reached the desired set-points. Of note, the latent and sensible heat extracted from the return air stream and returned back into the air stream via the reheat coils 26 along with the heat of compression provided by the compressors 32(a), (b) and (c), has been found to be sufficient to increase the temperature of the supply air stream beyond the temperature of the return air stream.

In the heating and dehumidification mode 106, the controller 88 activates recirculation loop A (control block 120); humidifier spray 96 is kept inactive. Then, the controller waits for a selected period of time then reads the return air temperature, supply air temperature, space temperature, and space humidity from temperature sensors 70, 76 78 and hygrometer 72, then compares these readings with the temperature and RH set-points (block 122). If the space temperature and humidity continue to be less than and greater than their respective set-points, then the controller 88 continues in the heating and dehumidification mode and proceeds to activate the second recirculation loop B to increase the heating and dehumidification (block 124). Then, the controller 88 waits another selected period and reads the aforementioned sensors again (block 126). If necessary, the controller 88 activates the third recirculation loop C (block 128). All three recirculation loops A, B, C are activated until the space temperature and humidity have reached the desired set-points.

In the cooling and dehumidification mode 108, the controller 88 activates recirculation loop A, by starting up its compressor 32(A) and setting its diverting valve 40(A) to divert refrigerant to the external coils 36 (control block 130); the humidifier spray 96 is left inactive. Then, the controller waits for a selected period of time then reads the return air temperature, supply air temperature, space temperature, and space humidity from temperature sensors 70, 76 78, and hygrometer 72, as well as the speed of the outside fan from fan status sensor 86. The controller 88 then compares these readings with the temperature and RH set-points (block 132). If the space temperature and humidity both continue to be greater than their respective set-points, then the controller continues in the cooling mode and proceeds to activate the second recirculation loop B to increase the cooling (block 134). Also, if the outside fan 38 is not already operating at full speed, the controller 88 sends a control signal to increase the outside fan speed, thereby increasing the air flow rate past the external condenser 36 and increasing the heat dissipation rate from the external condenser 36. Then, the controller 88 waits another selected period and reads the aforementioned sensors again (block 136). If necessary, the controller 88 activates the third recirculation loop C (block 138). All three recirculation loops A, B, C are activated until the space temperature and humidity have reached the desired set-points.

Of note, the cooled supply air will necessarily have the same or higher RH as the return air, as the decrease in air temperature may reduce the dewpoint. However, if the RH of the return air is close to or at 100%, the cooling process will extract water from the return air, so that the supply air will have less absolute water content than the return air (even though it has a higher RH) thereby serving to dehumidify the greenhouse space.

In the cooling and humidification mode 110, the controller 88 activates recirculation loop A, by starting up its compressor 32(A) and setting its diverting valve 40(A) to divert refrigerant to the external coils 36 (control block 140), and to activate the humidifier spray 96. Then, the controller 88 waits for a selected period of time then reads the return air temperature, supply air temperature, space temperature, and space humidity from temperature sensors 70, 76 78 and hygrometer 72 as well as the speed of the outside fan 38 from fan status sensor 86. Then, the controller 88 compares these readings with the temperature and RH set-points (block 142). If the space temperature and humidity continue to be greater than and less than their respective set-points, then the controller 88 continues in the cooling and humidification mode and proceeds to activate the second recirculation loop B to increase the cooling (block 144), and if necessary, the speed of outside fan 38. Then, the controller 88 waits another selected period and reads the aforementioned sensors again (block 146). If necessary, the controller 88 activates the third recirculation loop C (block 148). All three recirculation loops A, B, C are activated until the space temperature and humidity have reached the desired set-points.

By operating the air processing units 12 of the system 10 to control the RH and temperature inside the greenhouse A, the roof vents of the greenhouse A can be kept closed most or all of the time. This is advantageous as opening the roof vents to reduce the RH in the greenhouse A also allows significant amount of heat to escape, as well to allow cold air outside air to drop down on to the crop, which may in fact shock the crop. While this may be desirable when the greenhouse space is hotter than the desired set-point, it is undesirable when the greenhouse space is colder that the set-point. By keeping the roof vents closed, heat is lost mostly by conduction through the greenhouse walls and roof. It is believed that operating the air processing unit 12 has an added advantage of creating an moving pattern of warm air-flow inside only part the greenhouse thereby serving to reduce the amount of heat lost through conduction out of the greenhouse. That is, by discharging warm air into the greenhouse A through the micro-air distribution tubes 56 near to or within the actual crop foliage and extracting warm air from the greenhouse A through the elevated return air inlet 60; it is believed that a temperature gradient is formed in which relatively still colder air is maintained near the top of the greenhouse and acts as a buffer to slow down the rate of convective heat transfer towards the greenhouse roof, and a “micro air climate” of moving warm air is maintained between the ground to around the crop canopy.

In particular, it is believed that distributing heated air directly into the crop area in a horizontal fashion, is beneficial to reducing heating requirements of the greenhouse. First, heat is transferred directly to the crops, thereby minimizing heat loss out of the greenhouse via conduction etc. and minimizing heating areas inside the greenhouse A that do not need to be heated. An added benefit is achieved when the air processing units 12 are operating in dehumidification mode, as the unsaturated supply air will serve to absorb water vapor transpired by the crops as the air rises past the crops. Such absorption reduces the RH in the vicinity of the crops thereby improving the plants' health and reducing the occurrence of pests and occurrence of disease. Such absorption also captures the latent heat in the transpired water vapor, which is later reclaimed by the air processing unit to keep the greenhouse warm.

It is believed that the latent and sensible heat resident in the greenhouse air is substantial and due largely to the energy expended by crops during transpiration. Therefore, by maintaining the roof vents closed to prevent heat from escaping, by returning sensible and latent heat absorbed by the evaporation coils 24 back into the supply air stream via reheat coils 26, and by adding heat into the supply air stream from the heat of compression of the compressors 32, it is expected that the energy used to heat the greenhouse will be substantially reduced.

### EXAMPLES

The following are test results gathered on Jan. 27, 2003 between 12AM to 8AM from a greenhouse in Langley B. C. having installed therein four air processing units 12. In summary, the units 12 were solely operated to maintain the temperature and RH set points inside the greenhouse, i.e. the greenhouse heating boilers were turned off throughout this period. An inside temperature of between 10.5 and 11° C. was desired, in combination with a maximum humidity ratio equivalent to 75% RH at 12° C. The actual temperature and RH maintained by the units was 10.8° C. at 85% RH (equivalent to 68% RH at 12° C.). The units 12 produced a total of 1,003,123 BTU of heat over the eight hour period. Taking into consideration that the supply air ducts were riot insulated, it was estimated that about 10% of heat was lost through the supply air ducts, resulting in about 902,811 BTU heat supplied to the inside of the greenhouse over the eight hour period. This represents an over 86% energy savings over the natural gas boilers used at the Langley greenhouse to provide hot water radiant heating to the inside of the greenhouse.

The Langley greenhouse dimensions were measured to be:

| Length (per bay): | 250 | ft. | | |
|---|---|---|---|---|
| Width (per bay): | 11.25 | ft. | | |
| Bays: | 20 | | | |
| Rafter height: | 5.75 | ft. (gutter to peak) | | |
| Total length: | 250 | ft. | | |
| Total width: | 225 | ft. | | |
| Side wall height: | 15.6 | ft. (ground to gutter height) | | |
| End wall height: | 15.6 | ft. | | |
| End gablette: | 2.58 | ft. (ground to peak, less side wall height) | | |
| Site size | 56,250 | sq. ft. | Air volume | 950,063 cubic feet |

Based on industry accepted standards for determining heat loss in a greenhouse, it was estimated that the closed-vent air change factor for this greenhouse was 0.5, and cracked-vent air change factor was 12.6. Based on the measured greenhouse dimensions, the estimated heat loss caused by this air change is 8550.6 BTU/hr/° F. between outside and inside temperatures with the roof vents closed. With the vents open, and thus allowing free air movement, the heat loss estimate increases to 215,474 btu/hr/° F.

The industry-accepted standard for estimating conductive heat lost is based on calculating the square footage of the exposed areas, by each of the different sections of the facility. The square footage calculation is then multiplied by the “u-factor” (inverse of R rating) of the cladding material. This provides a heat loss for the particular area for one degree Fahrenheit. As an example, if a roof panel is 5.75 ft×250 long, it has an area of 1437.5 sq ft. If the cladding is single glass, which has a u-factor of 1.1, the area and u-factor are multiplied (1437.5×1.1) to get 1581.25 btu/hr per 1 degree Δ T (difference between inside and outside). In a peak-type greenhouse having two roof panels per bay, and 20 bays there is a heat loss of 63,250 btu/hr per 1 degree Delta T for the roof area (2×20×1581.25).

Langley greenhouse site heat loss expressed in btu/hr

| | | Closed-vent | | Cracked-vent |
|---|---|---|---|---|
| Roof | | 63,250 | | same |
| Side wall | | 8,580 | | same |
| End wall | | 7,722 | | same |
| Roof gable | | 638.55 | | same |
| Perimeter | | 380. | | same |
| Sub total | | 80,570.55 | | 80,570.55 |
| Air change factor | .5 | 8,550.6 | 12.6 | 215,474.2 |
| Total | (x) | 89,121.11 | | 296,044.75 |
| Delta T | | | | btu/hr 1 degree |

Night of January 27/03

| Average inside temperature | | 10.8° C. or | 51.4° F. (a) |
|---|---|---|---|
| Average outside temperature | | 6.7° C. or | 44° F. (b) |
| Resulting Delta T | (y) | 4.1° C. or | 7.4° F. (a-b) |

The average outside temperature measured between 12AM and 8AM on Jan. 27, 2003 outside the Langley greenhouse: 4.1 C (44.0° F.). The average inside temperature was 10.8° C. (51.4° F.). Thus, the average Δ T was 7.4° F., the total BTU lost over the eight hour period inside the greenhouse, with closed vents, is estimated to be 5,275,970 BTUs. In other words, the natural gas boilers would have to provide this amount of heat energy to maintain the inside temperature of the greenhouse at its set point. Operating at 80% efficiency, it is estimated that the boilers would have to burn 6,594,962 btu's of fuel to produce the desired output over the 8 hour period, as shown in Table 1 below:

TABLE 1
Theoretical Greenhouse Heat Loss and Boiler Input

| | | | Boiler input of |
|---|---|---|---|
| | Total heat loss | Total heat lost | natural gas boiler |
| | (x times y) | over 8 hours | operating at 80% |
| hours | per hour (BTU) | (BTU) | efficiency (BTU) |
| With roof | 659,496 | 5,275,970 | 6,594,962 |
| vents closed | | | |
| With vents | 2,190,731 | 17,525,848 | 21,907,310 |
| cracked | | | |

On Jan. 27, 2003 between 12AM and 8AM, the boilers were shut off, and only the four air processing units 12 were operated to provide heat and control the humidity of the greenhouse. Each processing unit had three recirculation loops (1,2,3); the compressor for each loop were rated at 10 hp, 7.5 hp, and 7.5 hp respectively. The compressors used were models ZR125KC (10 hp), and ZR94KC (7.5 hp), both manufactured by Copeland. Tables 2-5 below show the amount of usage of each compressor in each air processing unit to maintain the set-point conditions. The evaporation capacity, latent heat and heat of compression were obtained from data charts provided by the compressor manufacturer:

TABLE 2
Air Processing Unit A

| | Recirculation | Recirculation | Recirculation |
|---|---|---|---|
| | Loop 1 | Loop 2 | Loop 3 |
| Total compressor | 2 hours | 2 hours | 2 hours |
| operating time (hours) | 40 minutes | 40 minutes | 40 minutes |
| Evaporator capacity | 91,620 | 67,500 | 67,500 |
| (BTU/hr) | | | |
| Latent heat (BTU/hr) | 32,067 | 23,625 | 23,625 |
| Heat of Compression | 31,820.4 | 23,688.6 | 23,688.6 |
| (BTU/hr) | | | |
| Total heat output/hour | 63,887.4 | 47,313.6 | 47,313.6 |
| (BTU/hr) | | | |
| Total output (BTU) | 170,366 | 126,170 | 126,170 |
| Total combined output | | | 422,706 |
| (BTU) | | | |

TABLE 3
Air Processing Unit B

| | Recirculation | Recirculation | Recirculation |
|---|---|---|---|
| | Loop 1 | Loop 2 | Loop 3 |
| Total compressor | 2 hours | 2 hours | 0 |
| operating time (hours) | 40 minutes | 40 minutes | |
| Evaporator capacity | 91,620 | 67,500 | 0 |
| (BTU/Hr) | | | |
| Latent heat (BTU/Hr) | 32,067 | 23,625 | 0 |
| Heat of Compression | 31,820.4 | 23,688.6 | 0 |
| (BTU/Hr) | | | |
| Total heat output/hour | 63,887.4 | 47,313.6 | 0 |
| (BTU/Hr) | | | |
| Total output (BTU) | 170,366 | 126,170 | 0 |
| Total combined output | | | 296,536 |
| (BTU) | | | |

Note:
Compressor # 3 was turned off in error

TABLE 4
Air Processing Unit C

| | Recirculation | Recirculation | Recirculation |
|---|---|---|---|
| | Loop 1 | Loop 2 | Loop 3 |
| Total compressor | 0.0 | 2 hours | 20 minutes |
| operating time (hours) | | 40 minutes | |
| Evaporator capacity | 0 | 67,500 | 67,500 |
| (BTU/Hr) | | | |
| Latent heat (BTU/Hr) | 0 | 23,625 | 23,625 |
| Heat of Compression | 0 | 23,688.6 | 23,688.6 |
| (BTU/Hr) | | | |
| Total heat output/hour | 0 | 47,313.6 | 47,313.6 |
| (BTU/hr) | | | |
| Total output (BTU) | 0 | 126,170 | 15,771 |
| Total combined output | | | 141,941 |
| (BTU) | | | |

Note:
because of mechanical problems, the first compressor was not operated.

TABLE 5
Air Processing Unit D

| | Recirculation | Recirculation | Recirculation |
|---|---|---|---|
| | Loop 1 | Loop 2 | Loop 3 |
| Total compressor | 0.0 | 2 hours | 20 minutes |
| operating time (hours) | | 40 minutes | |
| Evaporator capacity | 0 | 67,500 | 67,500 |
| (BTU/hr) | | | |
| Latent heat (BTU/hr) | 0 | 23,625 | 23,625 |
| Heat of Compression | 0 | 23,688.6 | 23,688.6 |
| (BTU/hr) | | | |
| Total heat output/hour | 0 | 47,313.6 | 47,313.6 |
| (BTU/hr) | | | |
| Total output (BTU) | 0 | 126,170 | 15,771 |
| Total combined output | | | 141,941 |
| (BTU) | | | |

Note:
because of mechanical problems, the first compressor was not operated.
Notes:
system operating temperatures evaporator 26° F.
Condenser 120° F.

The following calculations are based on Copeland charts for determining evaporator capacity:

ZR125KC Compressor Chart (10 HP)

Under capacity: temp>30 20 ((99300−80100)/10×6)+80100=91,620

BTU/HR

then latent capacity is calculated by taking 35% of the evaporator capacity expressed in BTU/HR (91620×0.35)=32,067 BTU/HR Heat of compression is calculated by using “power (watts) table from manufacturer

Under power: temp>30 20 ((9850−9760)/10×6)+9760×3.413×0.95=31,820

BTU/HR

ZR94KC Compressor Chart (7.5 HP)

Under capacity: temp>30 20 ((73500−58500)/10×6)+58500=67,500

BTU/HR

then latent capacity is calculated by taking 35% of the evaporator capacity expressed in BTU/HR (67500×0.35)=23,625 BTU/HR Heat of compression is calculated by using “power (watts) table from manufacturer

Under power: temp>30 20 ((7310−7300)/10×6)+7300×3.413×0.95=23,688.6

BTU/HR

The total heat output generated by operation of the air processing units are 422,706+296,536+141,941=1,003,123 BTU. Accounting for an estimated 10% heat loss due to uninsulated supply air ducting, it is estimated that 902,811 BTU were provided by the air processing units into the greenhouse. This represents a 86.31% energy reduction over the use of boilers to heat the greenhouse.

While the present invention has been described herein by the preferred embodiments, it will be understood to those skilled in the art that various changes may be made and added to the invention. The changes and alternatives are considered within the spirit and scope of the present invention.

1. An air processing unit for a greenhouse comprising:
(a) an air processing conduit having an inlet for receiving return air from inside a greenhouse, an outlet for discharging processed supply air, and an air flow path extending from the inlet to the outlet and in which the return air is processed into supply air,
(b) a heat sink in the air flow path operable to extract heat and condense water from return air flowing through the air flow path;
(c) an exterior heat rejector outside the air flow path and capable of thermally coupling to the heat sink such that heat removed from the air flow path by the heat sink is discharged from the air processing unit by the exterior heat rejector;
(d) an interior heat source inside the air flow path and capable of thermally coupling to the heat sink such that heat removed from the air flow path by the heat sink is returned back to the air flow path by the interior heat source;
(e) means for thermally coupling the heat sink to the exterior heat rejector during a cooling cycle, and to the interior heat source during a heating cycle; and
(f) a supply air distribution array fluidly coupled to the air processing conduit outlet and located inside the greenhouse in the vicinity of a crop grown inside the greenhouse, for discharging the processed supply air into the foliage area of the crops.

2. An air processing unit of claim 1 wherein the heat sink is an evaporator, the external heat rejector and internal heat source are condensers, the thermal coupling means is a diverting valve, and the evaporator, external condenser, internal condenser and diverting valve are fluidly coupled to a refrigerant recirculation loop, the air processing unit further comprising a compressor coupled to the recirculation loop downstream of the evaporator and operable to compress a refrigerant that has absorbed heat from the evaporator thereby enabling the absorbed heat to be discharged from the refrigerant through one of the external and internal condensers.

3. An air processing unit of claim 2 further comprising a carbon dioxide injector located in the air flow path and fluidly connectable to a carbon dioxide source.

4. An air processing unit of claim 2 further comprising a oxygen injector located in the air flow path and fluidly connectable to a oxygen source.

5. An air processing unit of claim 2 further comprising a nitrogen injector located in the air flow path and fluidly connectable to a nitrogen source.

6. An air processing unit further of claim 2 further comprising a humidifier located in the air flow path and fluidly connectable to a water source.

7. An air processing unit of claim 2 further comprising a return air duct fluidly coupled to the air processing conduit inlet, and having an inlet in fluid communication with the inside of a greenhouse, the return air duct inlet located above the canopy of the crops.

8. An air processing unit of claim 1 wherein the air distribution array comprises a manifold in fluid communication with the air processing conduit outlet, and at least one elongated perforated distribution tube fluidly coupled to the manifold, whereby supply air is discharged through the perforations.

9. An air processing unit of claim 8 wherein the air distribution array further comprises a frame supporting the distribution tube at selectable heights between the ground of the greenhouse and the crop canopy.

10. An air processing unit of claim 9 further comprising a flexible interconnect tube flexibly coupling the manifold to the air processing unit outlet thereby enabling the height of the manifold and distribution tubes to be changed relative to the air processing unit outlet.

11. An air processing unit of claim 8 wherein the distribution array comprises a plurality of distribution tubes extending longitudinally from the manifold in a substantially parallel spaced configuration.

12. An air processing unit of claim 11 wherein the perforations are positioned on the distribution tubes such that the discharged supply air creates a substantially horizontal, crisscrossing air flow pattern in the vicinity of the crops.

13. A method of heating and dehumidifying a greenhouse, comprising:
(a) obtaining air from the inside of a greenhouse, the air including water vapour transpired by a crop grown inside the greenhouse;
(b) cooling and dehumidifying the air, thereby extracting sensible heat and water from the air, and latent heat from the condensation of the water vapour;
(c) converting the latent heat into sensible heat, and returning the converted and extracted sensible heat back into the air; and
(d) discharging the heated and dehumidified air back into the greenhouse in the vicinity of the crops,
thereby reducing the need for greenhouse venting to control the humidity inside the greenhouse, and reducing the heat lost as a result of such venting.

14. A method as claimed in claim 13 wherein the air is obtained from a location inside the greenhouse above the canopy of the crop.

15. A method as claimed in claim 13 wherein the air is obtained from a location above the crop canopy and below a roof shade system and gutter level of the greenhouse.

16. A method as claimed in claim 14 wherein the heated and dehumidified air is discharged from a plurality of air flows in the vicinity of the crops.

17. A method as claimed in claim 15 wherein the heated and dehumidified air is discharged from a plurality of substantially horizontal air flows, thereby creating a crisscrossing pattern of air flows in the vicinity of the crops.

18. A method as claimed in claim 17 wherein the horizontal air flows are located at a height in the vicinity of the crop canopy height.

19. A method of heating and dehumidifying a greenhouse, comprising:
(a) obtaining air from the inside of a greenhouse above the canopy of a crop grown inside the greenhouse, the air including latent heat in water vapour transpired by the crop;
(b) cooling and dehumidifying the air, thereby extracting sensible heat and water from the return air, and latent heat from the condensation of the water vapour;
(c) converting the latent heat into sensible heat, and returning the converted and extracted sensible heat back into the air; and
(d) discharging the heated and dehumidified air back into the greenhouse in the vicinity of the crops thereby creating a localized moving layer of warm that envelopes the crops,
thereby reducing the frequency of greenhouse venting to control the humidity inside the greenhouse, and the heat lost as a result of such venting.

20. A method as claimed in claim 19 wherein the creation of the warm air layer creates a layer of colder air above the crop canopy and near the peak of the greenhouse.
